(19) United States
(12) Patent Application Publication
(10) Pub. No.: US 2002/0100452 A1
(43) Pub. Date: Aug. 1, 2002

(54) Trochilic piston engine

(76) Inventor: George Bozdog, Tucson, AZ (US)

Correspondence Address: Garth Janke, BIRDWELL, JANKE & DURANDO, PLC, Suite 1925, 900 SW Fifth Avenue, Portland, OR, 97204, US

(21) Appl. No.: 10/043,758

(22) Filed: Jan. 9, 2002

(51) Int. Cl. F02B 53/00; F04B 17/00

(52) U.S. Cl. 123/245; 123/18 R; 417/364

(57) ABSTRACT

A trochilic piston engine. A plurality of trochilic pistons rotate about the cylindrical axis of an engine chamber. Each piston presents a pressure-bearing surface against which expanding gases exert a pressure tending to push the pressure-bearing surfaces of adjacent pistons, and therefore the adjacent pistons, apart. The engine includes a gear train comprising a fixed sun gear about which planetary gears associated with each piston revolve, the planetary gears being connected to an assembly for turning a drive-shaft. The pistons are connected to their respective planetary gears through respective crank arms having a sliding member coupled to an eccentrically disposed projection of the respective planetary gear. As the pistons rotate about the pivot point, the leverage that adjacent pistons exert on the respective eccentrically disposed projections varies in opposition over an engine cycle; however, the pistons are constrained to rotate in the same direction by the gear train.

### BACKGROUND OF THE INVENTION

The present invention relates to a trochilic piston engine with wide areas of application, including Stirling cycle, internal combustion, and high-pressure gas or fluid pumping.

The desire for improved engine performance is ever present. The reciprocating piston engine has well known theoretical and practical disadvantages, and the rotary engine which solves many of these problems creates well known problems of its own. For example, reciprocating pistons reverse momentum every engine cycle, which is wasteful of mechanical energy and stressful to mechanical parts. On the other hand, providing an efficient and durable seal in a rotary engine having an eccentrically mounted rotor is difficult, and it is difficult to ensure that an eccentrically mounted rotor does not induce vibration, especially at high frequencies of revolution. Moreover, sealing the combustion chambers in each of these types of engines creates friction between the piston rings or rotor and the cylinder or chamber walls, causing wear of these engine parts.

Accordingly, there is a need for a trochilic piston engine that provides for reducing the amount of momentum lost in moving mechanical parts as well as reducing the friction generated by such parts, which provides for increasing engine efficiency and durability and permits decreasing engine weight.

### SUMMARY OF THE INVENTION

The trochilic piston engine of the present invention solves the aforementioned problems and meets the aforementioned need by providing a plurality of trochilic pistons and a cylindrical chamber containing the pistons. The pistons rotate about the cylindrical axis of the chamber. Each piston presents a pressure-bearing surface against which expanding gases exert a pressure tending to push the pressure-bearing surfaces of adjacent pistons, and therefore the adjacent pistons, apart. The engine includes a gear train comprising a fixed sun gear about which planetary gears associated with each piston revolve, the planetary gears being connected to an assembly for turning a drive-shaft. The pistons are connected to their respective planetary gears through respective crank arms having a sliding member coupled to an eccentrically disposed projection of the respective planetary gear. As the pistons rotate, the leverage that adjacent pistons exert on the respective eccentrically disposed projections varies in opposition over an engine cycle; however, the pistons are constrained to rotate in the same direction by the gear train. Expanding gas is produced or provided at a point in the chamber between the pressure-bearing surfaces of two adjacent pistons, where the force on the pressure-bearing surface of one of the pistons is leveraged by the position of the eccentrically disposed projection with respect to the crank arm for that piston more than the force on the pressure-bearing surface of the other piston, so that both pistons turn together in a preferred direction.

Therefore, it is a principal object of the present invention to provide a novel and improved trochilic piston engine.

It is another object of the present invention to provide a trochilic piston engine that provides for reducing the amount of momentum lost in moving mechanical parts.

It is still another object of the present invention to provide a trochilic piston engine that provides for reducing the friction generated by moving mechanical parts.

It is yet another object of the invention to provide a trochilic piston engine that provides for increased engine efficiency and durability.

It is a further object of the invention to provide a trochilic piston engine that permits decreased engine weight.

The foregoing and other objects, features and advantages of the present invention will be more readily understood upon consideration of the following detailed description of the invention, taken in conjunction with the following drawings.

### BRIEF DESCRIPTION OF THE DRAWINGS

FIG. 1 is an exploded pictorial view of a piston and crank assembly for use in a trochilic piston engine according to the present invention.

FIG. 2 is an exploded pictorial view of a gear train according to the present invention for use with the piston and crank assembly of FIG. 1.

FIG. 3 is a plan view of the piston and crank assembly of FIG. 1 and the gear train of FIG. 2 installed in an engine chamber of the trochilic piston engine, showing first angular orientation of the pistons.

FIG. 4A is a schematic view of the piston and crank assembly of FIG. 1 and the gear train of FIG. 2 showing the same angular orientation of the pistons that is shown in FIG. 3.

FIG. 4B is a schematic view corresponding to FIG. 4A, showing an angular orientation of the pistons that is 22.5 degrees from that shown in FIG. 4A.

FIG. 4C is a schematic view corresponding to FIGS. 4A and 4B, showing an angular orientation of the pistons that is 45 degrees from that shown in FIG. 4A and 22.5 degrees from that shown in FIG. 4B.

FIG. 4D is a schematic view corresponding to FIGS. 4A and 4C, showing an angular orientation of the pistons that is 67.5 degrees from that shown in FIG. 4A and 22.5 degrees from that shown in FIG. 4C.

FIG. 4E is a schematic view corresponding to FIGS. 4A and 4D, showing an angular orientation of the pistons that is 90 degrees from that shown in FIG. 4A and 22.5 degrees from that shown in FIG. 4D.

FIG. 4F is a schematic view corresponding to FIGS. 4A and 4E, showing an angular orientation of the pistons that is 112.5 degrees from that shown in FIG. 4A and 22.5 degrees from that shown in FIG. 4E.

FIG. 4G is a schematic view corresponding to FIGS. 4A and 4F, showing an angular orientation of the pistons that is 135 degrees from that shown in FIG. 4A and 22.5 degrees from that shown in FIG. 4F.

FIG. 4H is a schematic view corresponding to FIGS. 4A and 4G, showing an angular orientation of the pistons that is 157.5 degrees from that shown in FIG. 4A and 22.5 degrees from that shown in FIG. 4G.

FIG. 4I is a schematic view corresponding to FIGS. 4A and 4H, showing an angular orientation of the pistons that is 180 degrees from that shown in FIG. 4A and 22.5 degrees from that shown in FIG. 4H.

FIG. 4J is a schematic view corresponding to FIGS. 4A and 4I, showing an angular orientation of the pistons that is 202.5 degrees from that shown in FIG. 4A and 22.5 degrees from that shown in FIG. 41.

FIG. 4K is a schematic view corresponding to FIGS. 4A and 4J , showing an angular orientation of the pistons that is 225 degrees from that shown in FIG. 4A and 22.5 degrees from that shown in FIG. 4J.

FIG. 4L is a schematic view corresponding to FIGS. 4A and 4K, showing an angular orientation of the pistons that is 247.5 degrees from that shown in FIG. 4A and 22.5 degrees from that shown in FIG. 4K.

FIG. 4M is a schematic view corresponding to FIGS. 4A and 4L, showing an angular orientation of the pistons that is 270 degrees from that shown in FIG. 4A and 22.5 degrees from that shown in FIG. 4L.

FIG. 4N is a schematic view corresponding to FIGS. 4A and 4M, showing an angular orientation of the pistons that is 292.5 degrees from that shown in FIG. 4A and 22.5 degrees from that shown in FIG. 4M.

FIG. 4P is a schematic view corresponding to FIGS. 4A and 4N, showing an angular orientation of the pistons that is 315 degrees from that shown in FIG. 4A and 22.5 degrees from that shown in FIG. 4N.

FIG. 4Q is a schematic view corresponding to FIGS. 4A and 4P, showing an angular orientation of the pistons that is 337.5 degrees from that shown in FIG. 4A and 22.5 degrees from that shown in FIG. 4P.

FIG. 5 is a plan view of the piston and crank assembly of FIG. 1 and the gear train of FIG. 2 installed in an engine chamber of the trochilic piston engine, corresponding to FIG. 4M.

FIG. 6 is a plan view of the piston and crank assembly of FIG. 1 and the gear train of FIG. 2 installed in an engine chamber of the trochilic piston engine, corresponding to FIG. 4C.

FIG. 7 is a plan view of the piston and crank assembly of FIG. 1 and the gear train of FIG. 2 installed in an engine chamber of the trochilic piston engine, corresponding to FIG. 4P.

FIG. 8 is a side section view of a trochilic piston engine according to the present invention.

FIG. 9 is an exploded section view of a trochilic piston engine according to the present invention.

FIG. 10 is an exploded section view of the gear train of FIG. 2.

FIG. 11 is an end view of the gear train of FIG. 10, taken along a line 11-11 thereof

FIG. 12 is an end view of the gear train of FIG. 10, taken along a line 12-12 thereof

### DETAILED DESCRIPTION OF A PREFERRED EMBODIMENT

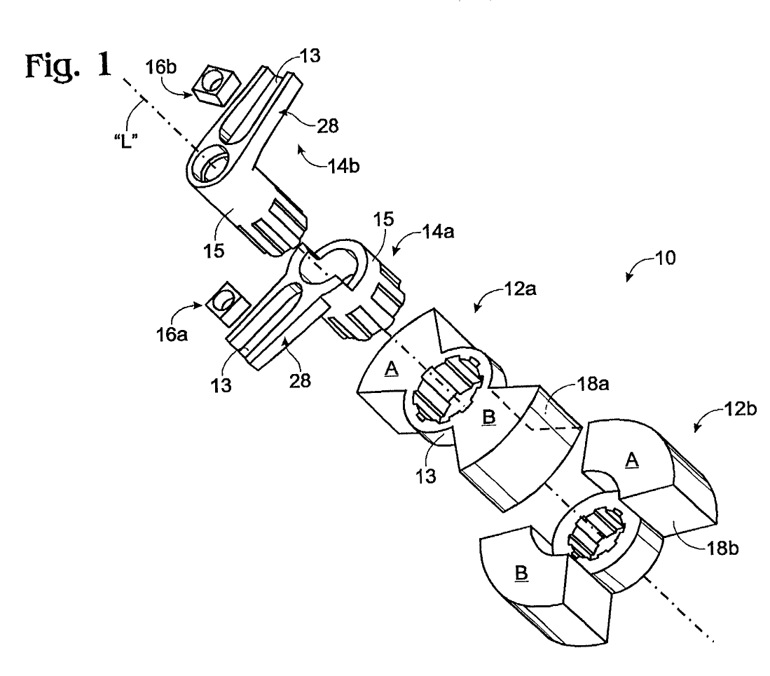

Referring to FIG. 1, a piston and crank assembly 10 is shown for a trochilic piston engine according to the present invention. The assembly 10 includes a pair of pistons 12a, 12b and a corresponding pair of crank arms 14a, 14b along with slide members 16a, 16b. Each crank arm includes a channel 13 adapted to receive a respective slide member 16 and to permit sliding of the slide member in the channel while constraining the slide member to reciprocating linear motion.

The pistons are assembled so that a pressure-bearing surface 18a of one of the pistons 12a faces a similar pressure-bearing surface 18b of the other piston 12b. The pressure-bearing surfaces have the shape and area so as to define a volume between these surfaces for containing an expanding gas. The pistons advantageously have two lobes “A” and “B” defining two such volumes. The remaining sides of the volume are provided by a containment chamber that is not shown in FIG. 1 and that constrains the pistons to rotate about a power output axis “L” as discussed below. Each piston 12 is independently coupled to its respective crank arm 14, e.g., by splines as shown.

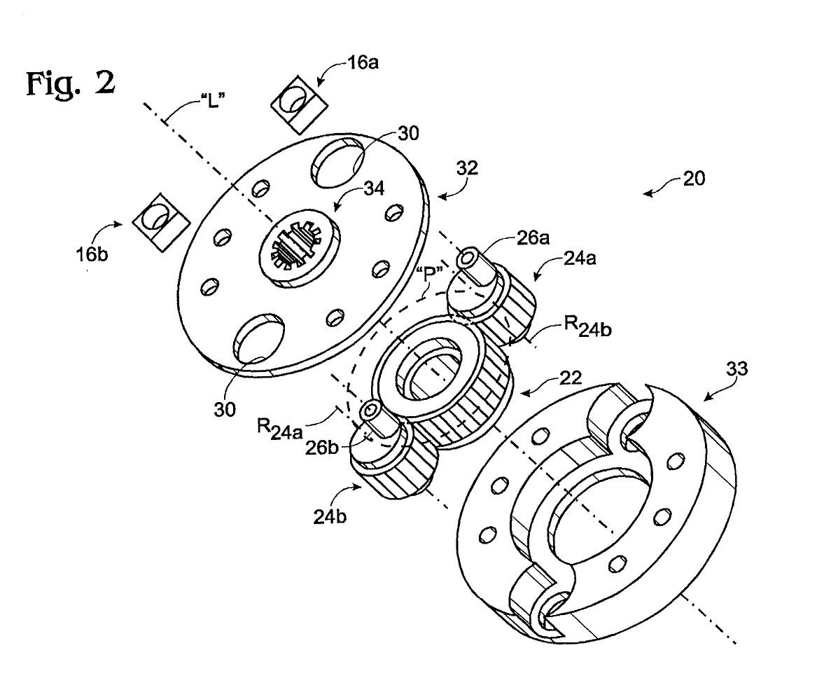

FIG. 2 shows a gear train 20 according to the present invention. This includes a sun gear 22 and planetary gears 24a, 24b corresponding to the slide members 16a, 16b of FIG. 1. The sun gear is fixedly mounted to a block of the engine that is not shown in FIG. 2, and is concentric with the power output axis “L.” Centers of rotation R₂₄ₐ and R_{24b} of the planetary gears are constrained to orbit the sun gear about a circular path “P” that is also concentric with the power output axis “L,” the planetary gears being captured between a driving disc 32 and a housing 33.

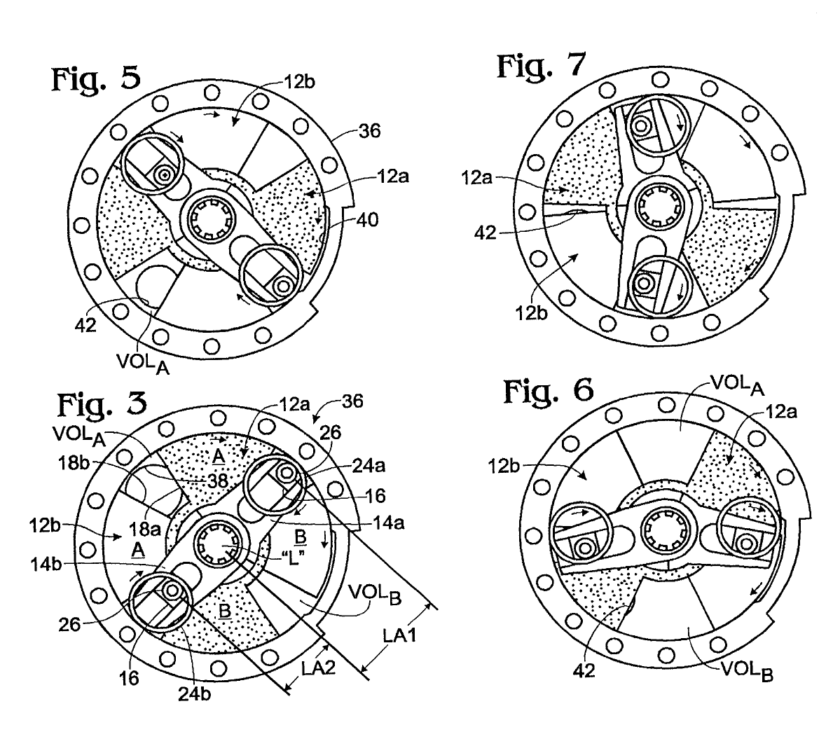

The planetary gears include respective eccentrically disposed projections 26a, 26b that provide levers for rotating the planetary gears about the centers of rotation R₂₄. Similarly, ends 28 of the crank arms 14 (FIG. 1) provide levers for the pistons. The piston and crank assembly of FIG. 1 is coupled to the gear train 20 of FIG. 2 via the slide members 16, such as indicated in FIG. 3, so that rotary motion of the crank arms about the power output axis “L” is transmitted to the eccentrically disposed projections 26 for rotating the planetary gears 24 through the aforedescribed reciprocating linear motion of the slide members.

Orbital movement of the planetary gears provides the power output of the engine.

The planetary gears 24 may be coupled, e.g., by extending through holes 30 of the disc 32, to a spline 34 adapted to receive a drive-shaft.

Turning to FIG. 3, a top view of a sub-assembly of the trochilic piston engine comprising the piston and crank assembly of FIG. 1 with the gear train 20 of FIG. 2 is shown, wherein only the planetary gears 24 of the gear train 20 with the eccentrically disposed projections 26 are shown for clarity.

As mentioned above, corresponding pressure-bearing surfaces 18 of adjacent pistons define a gas expansion volume between these surfaces for containing an expanding gas. This volume is further bound by a cylindrical containment chamber 36 shown in FIG. 3 that constrains the pistons to rotate about the power output axis “L.” Also as mentioned above, there are two lobes “A” and “B” of each piston 12; hence, there are four such volumes. Two of these volumes are representative and designated “Vol_{A}” and “Vol_{B}.”

In FIG. 3, the volume Vol_{A}, formed between the pressure-bearing surface 18a of the piston 12a and the pressure-bearing surface 18b of the piston 12b is in communication with a valveless intake port 38. Also in this Figure, effective lever arms “LA1” and “LA2” are identified that are associated, respectively, with pistons 12a and 12b, through the respective crank arms 14a and 14b. The lever arms represent the leverage applied by the respective pistons, through the associated crank arms 14 and slide members 16, to the eccentrically disposed projections 26 of the corresponding planetary gears 24.

In the angular position of the pistons that is shown, wherein the eccentrically disposed projections and the crank arms are all aligned with one another, the effective lever arm “LA1” corresponding to piston 12a is greater than the effective lever arm “LA2” corresponding to piston 12b. Thence, if a gas is introduced through the intake port 38 and it is either pressurized as it is introduced, or it is pressurized by combustion after it is introduced, the gas will exert an equal force against the surfaces 18a of the piston 12a and 18b of the piston 12b tending to push the pistons in opposite directions. However, over each quarter cycle of the engine, these forces are communicated to the gear train 20 by lever arms “LA1” and “LA2” of unequal length, so that the force exerted on the planetary gear 24a tending to rotate that planetary gear in the clockwise direction is larger than the force exerted on the planetary gear 24b tending to rotate the planetary gear 24b in the counterclockwise direction, so that both pistons are caused to rotate in the direction of the arrow. This is the basic action producing the output of the engine, which is repeated four times for four different gas volumes during a single rotation of the engine.

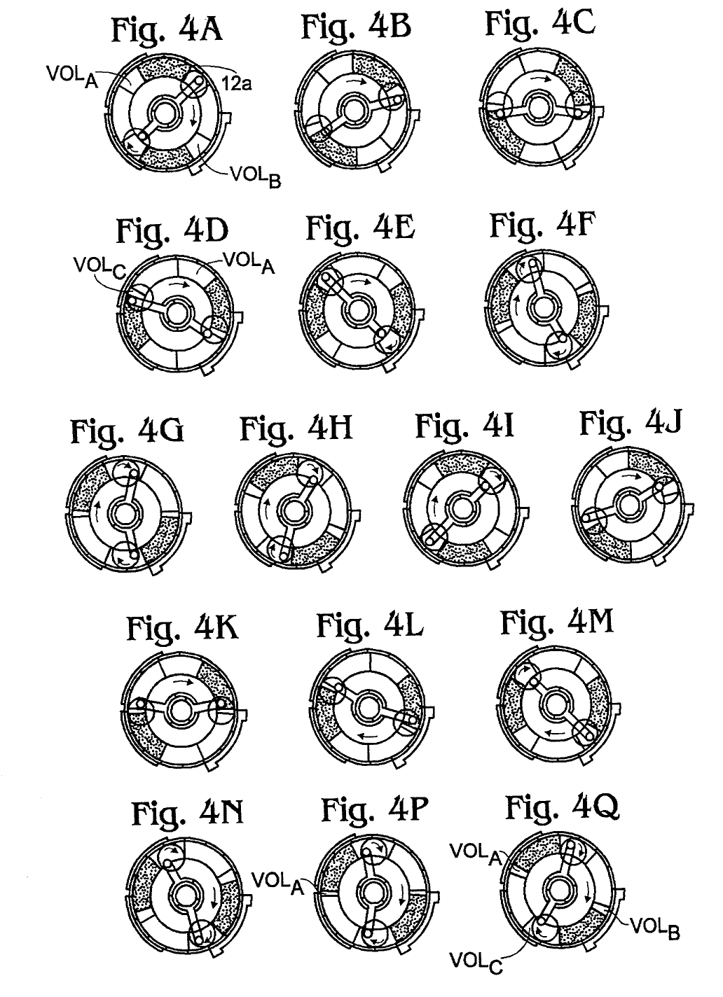

Referring to FIGS. 4A-4Q, a timing sequence is shown for the trochilic piston engine employing the aforementioned crank and piston assembly, and gear train. These Figures together show a complete 360 rotation of the engine in 22.5 degree increments (1/16 turn), starting with the orientation shown in FIG. 3. Piston 12a is shown stippled to contrast with piston 12b for clarity. FIG. 3 corresponds to FIG. 4A. For the force exerted by the expanding gas in the volume Vol_{A}, the lever arm “LA1,” defined in FIG. 3 is greater than the lever arm “LA2” for the one-quarter engine turn represented by FIGS. 4P-4C. At the same time the lever arm LA1 becomes less than the lever arm “LA2” for the force exerted by the gas in volume Vol_{A}, the lever arm “LA2” is greater than the arm “LA1” for the force exerted by the gas in the volume Vol_{C} that expands next in the cycle.

Referring to FIG. 5, the crank arms of the two pistons 12 are aligned as shown in FIG. 4M, which represents a 270 degree rotation of the engine. Here, a valveless exhaust port 42 is uncovered by the pistons for exhausting the volume Vol_{A}.

A Stirling cycle may be initiated by the volume Vol_{A} expanding as it passes the intake port 38 taking in a dense working gas, e.g., from a reservoir. Preferably, a heated expansion cavity or relief 40 is provided in the interior side of the chamber 36 that exposes the working gas to a relatively large heated surface that is not blocked by the piston as the piston rotates, for expanding the gas to drive the pistons.

Operation of the engine over a cycle is illustrated sequentially by FIGS. 3, 6, 5 and 7. Referring back to FIG. 3, the engine is started in the direction of the arrows. A working gas is introduced into the volume Vol_{A} between the pistons 12a and 12b as an “intake” portion of the cycle is initiated. The volume Vol_{A} is in fluid communication with the intake port 38 which is, therefore, “open.” The intake port, in turn, is in communication with a reservoir (not shown) for a working gas.

Turning to FIG. 6, the planetary gears have orbited 45 degrees from their positions in FIG. 3. The volume Vol_{A} is at the end of the intake portion of the cycle, i.e., the intake port 38 (FIG. 3) is covered by the piston 12b and is, therefore, “closed.” At the same time, the volume Vol_{A} is beginning a “compression” portion of the cycle.

Referring back to FIG. 5, the planetary gears have orbited 225 degrees from their positions in FIG. 6. The volume Vol_{A} is in an “exhaust” portion of the cycle, i.e., the exhaust port 42 is open. Turning to FIG. 7, after an additional 45 degrees of orbit of the planetary gears, the “exhaust” portion of the cycle for the volume Vol_{A} is now substantially completed, as the exhaust port is now substantially closed.

It should be noted that the volume Vol_{B}, as do all of the gas volumes defined by the pistons 12, also cycles through its own intake and exhaust portion of the cycle that is offset from those for the volume Vol_{A}. Particularly, the cycle for Vol_{B} is offset from that of Vol_{A} by 180 degrees of rotation of the planetary gears. For example, in FIG. 6, as the intake portion of the cycle for the volume Vol_{A} is just completed, the volume Vol_{B} is just commencing its “exhaust” portion of the cycle, by beginning to open the exhaust port 42.

By adjusting the number of gear teeth in the planetary and sun gears, the gear train provides for a predetermined gear ratio of the number of revolutions of the planetary gears for a single revolution of orbit about the sun gear, i.e., a single revolution of the engine.

As indicated by comparing, e.g., FIG. 4A with FIG. 41, (showing 180 degrees of engine rotation) the planetary gears rotate about the sun gear three times for every revolution of the engine, so that this ratio is 3; however, equivalently, the planetary gears rotate about their axes R₂₄ (FIG. 2) twice for every revolution of the engine. A result of this arrangement is that, e.g., in FIGS. 4A, 4E, 4I, and 4M representing a sequence of four 90 degree intervals of engine rotation, the four gas volumes are sequentially made to be in communication with the intake port 38 and to exert the leverage on the crank arms shown in FIG. 3. In general, the two revolutions of the planetary gears about their axes for a given engine cycle, providing four 180 degree reversals of the eccentrically mounted projections 26 (FIG. 2), provides that each of the four gas volumes are treated alike throughout repeated cycles of the engine, the action of the four volumes respectively being delayed by 0, 90, 180, or 270 degrees. Accordingly, it may be necessary or desirable to change the gear ratio where a different number of volumes are created, e.g., by use of a different number of pistons.

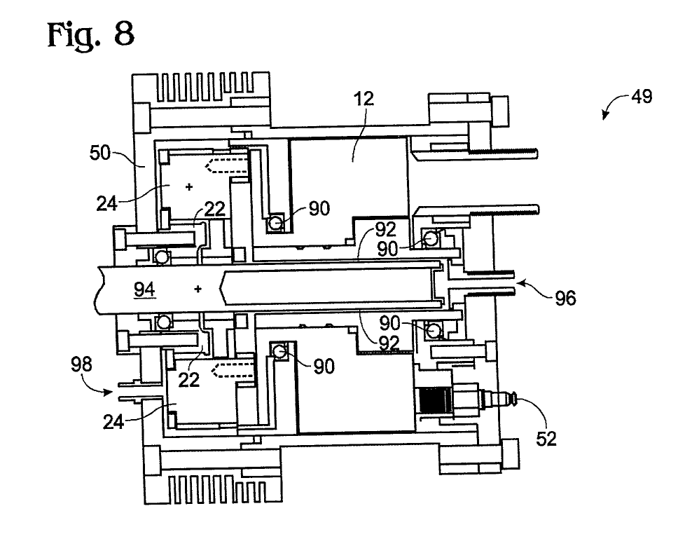

Referring to FIG. 8, a cross-section of a trochilic piston engine 49 having the aforedescribed structure is shown. The engine has an engine block 50 to which the sun gear 22 is fixedly mounted. A spark plug 52 is shown to illustrate that the engine may be used as an internal combustion engine, e.g., with a conductive or combustible gas;

however, with suitable modification the engine may as well be used with pre-heated gases introduced through the port 38. The heat source may be any of a number of alternatives, such as a torch, catalytic heater, or solar collector. Preferably, the operating temperature range is 500-750 degrees C. The engine may also be used as a pump by applying torque to the drive-shaft.

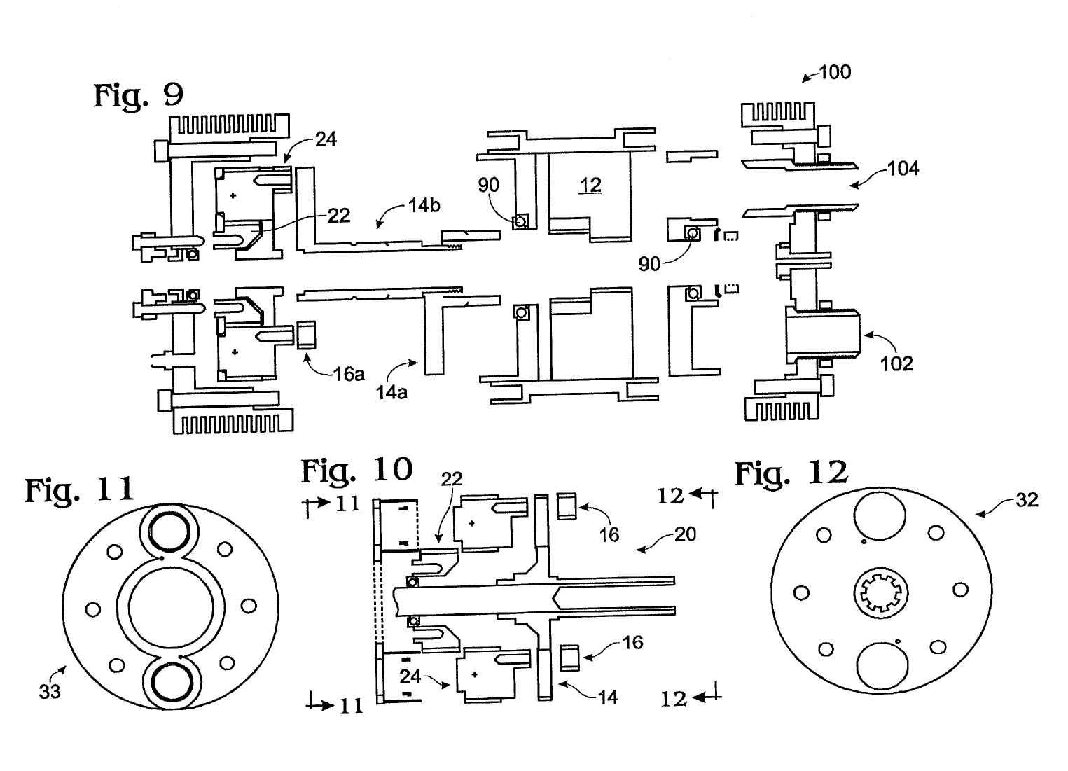

Turning to FIG. 9, an exploded view of an engine 100 very similar to the engine of FIG. 8 is shown. The engine is shown in FIG. 9 without a spark plug, such as may be used for a Stirling cycle, wherein the cylinder includes the aforementioned expansion cavity. A gas exit portion 102 of the engine, in communication with the exhaust port 42 (FIG. 5), is visible in FIG. 9 and not shown in FIG. 8. A gas inlet portion 104 is in communication with the intake port 38 (FIG. 3). FIGS. 10-12 show just the gear train portion of the engine that was described above in connection with FIG. 2.

Preferably, no piston rings are employed to maintain gas-tightness of the volumes Vol_{A} and Vol_{B}, to keep friction to a minimum. Accordingly, the piston to chamber clearance should be held to very close tolerances, and bearings 90 that are adapted to resist both axial and lateral thrust are press-fit into the block 50, for supporting the pistons 12.

Oil is preferably pumped by the planetary gears 24, to the piston and crank arms and to a drive shaft 94, through an oil gallery 92 adjacent the drive-shaft. Holes (not shown) in the piston spline 13 as well as the crank arm bodies 15 (FIG. 1) are provided for communication between the planetary gears and the oil gallery 92. The oil is pumped to an oil outlet 96, where it is retrieved for return, at 98, to the planetary gears.

The trochilic piston engine of the present invention provides a number of outstanding advantages, including in particular an elegant rotational symmetry of the pistons that ensures a bare minimum of reciprocating motion, minimizing wasted mechanical motion and resultant mechanical stress to provide for greatly increased efficiency and durability as well as lighter weight.

It is to be recognized that, while a particular trochilic piston engine has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A trochilic piston engine, comprising:
a cylindrical engine chamber having a cylindrical axis; and
a plurality of pistons adapted to rotate about said cylindrical axis within said chamber, wherein said pistons have a center of rotational symmetry, and wherein said centers of rotational symmetry for said pistons are coincident with each other and with said cylindrical axis.

2. A trochilic piston engine, comprising:
a cylindrical engine chamber having a cylindrical axis;
a plurality of trochilic pistons, wherein two of said pistons are disposed adjacent one another so that associated pressure-bearing surfaces thereof oppose one another so as to define a gas expansion volume therebetween that is further bounded by said chamber for substantially containing an expanding gas for pushing said pressure-bearing surfaces and, therefore, said pistons apart in opposite directions of rotation; and
a gear train for coupling both of said two pistons together to provide an output of the engine, said gear train being adapted so that, during a predetermined cycle of the engine when said gas is expanding, one of said two pistons exerts a greater force on said output than the other, to produce a preferred direction of rotation of said output.

3. The trochilic piston engine of claim 2, wherein said pistons have two lobes, so that said two pistons define eight pressure-bearing surfaces defining four associated gas expansion volumes.

4. The trochilic piston engine of claim 2, wherein said gear train comprises a sun gear fixedly disposed with respect to said chamber an orbiting planetary gear associated with each of said two pistons, said planetary gears having respective eccentrically disposed projections for rotating the planetary gears about cylindrical axes thereof, said planetary gears being coupled together so as to remain fixedly angularly spaced apart with respect to said cylindrical axis, and a crank arm assembly independently coupling each of said two pistons to the eccentrically disposed projection of a respective one of said planetary gears, so that turning at least one of said two pistons about said cylindrical axis causes said planetary gears to rotate about said sun gear and thereby to provide said output.

5. The engine of claim 4, wherein said crank arm assembly includes, for each of said pistons, a crank arm rigidly coupled to the piston, said crank arms each being adapted to receive an associated slide member having a linear reciprocating motion with respect thereto, said slide members being coupled to the eccentrically disposed projection of a respective one of said planetary gears.

6. The engine of claim 4, wherein said sun and planetary gears are adapted so that one orbit of said planetary gears about said sun gear corresponds to 720 degrees of rotation of said planetary gears about respective cylindrical axes thereof.

7. The engine of claim 5, wherein said sun and planetary gears are adapted so that one orbit of said planetary gears about said sun gear corresponds to 720 degrees of rotation of said planetary gears about respective cylindrical axes thereof.
